(19) United States
(12) Patent Application Publication
(10) Pub. No.: US 2026/0322249 A1
(43) Pub. Date: Oct. 15, 2026

(54) Low Dropout Regulator with Ripple Rejection

(71) Applicant: SG MICRO CORP, Beijing (CN)

(72) Inventor: Yu LIN, Beijing (CN)

(73) Assignee: SG MICRO CORP, Beijing (CN)

(21) Appl. No.: 18/880,292

(22) PCT Filed: Aug. 15, 2024
(86) PCT No.: PCT/CN2024/112385

§ 371 Date: Dec. 31, 2024

(30) Foreign Application Priority Data
Dec. 18, 2023 (CN) 202311737810.0

(51) Int. Cl. H02M 1/14; H02M 1/15

(52) U.S. Cl. CPC H02M 1/143; H02M 1/15

(57) ABSTRACT

A Low Dropout Regulator (LDO) with ripple rejection includes an LDO main circuit, a ripple introduction capacitor, and a first resistor, wherein the LDO main circuit is configured to control an output voltage of the LDO according to a control loop formed by an error amplifier and a power transistor; the ripple introduction capacitor is configured to introduce a ripple at an input end of the LDO into the control loop through the error amplifier; and the first resistor is configured to isolate the ripple at the input end of the LDO from an output end of the LDO. The problems that the structure of a circuit for canceling an LDO output ripple with Feed-Forward Ripple Cancellation (FFRC) is complex, and the stability and transient response of a circuit are affected are solved.

### CROSS REFERENCE TO THE RELATED APPLICATIONS

This application is the national phase entry of International Application No. PCT/CN2024/112385, filed on Aug. 15, 2024, which is based upon and claims priority to Chinese Patent Application No. 202311737810.0, filed on Dec. 18, 2023, the entire contents of which are incorporated herein by reference.

### TECHNICAL FIELD

Embodiments of the present disclosure relate to the technical field of power management, and in particular, to a Low Dropout Regulator (LDO) with ripple rejection.

### BACKGROUND

An LDO is a new generation of integrated circuit voltage regulator. The LDO is a micro system on chip with very low consumption, which may be configured for current main channel control, and has the functions such as over-current protection, over-temperature protection, a precision reference source, a differential amplifier, a delayer, etc. Under normal circumstances, an output voltage of the LDO does not vary with changes in an input voltage, with large fluctuations in input and small fluctuations in output. In order to reject an output ripple and improve Power Supply Rejection (PSR), a ripple rejection circuit is proposed in the related art, in which Feed-Forward Ripple Cancellation (FFRC) is one of the commonly used ripple suppression manners. The principle of FFRC is to introduce the ripple of a power supply (input voltage) at an output stage of an error amplifier of the LDO, and add a summing circuit, so as to reject the output ripple through a power transistor.

As shown in FIG. 1, which is a relatively common example circuit diagram of applying FFRC to reject an LDO output ripple, where Feedforward Amplifier is a feedforward operational amplifier unit, and Summing Amplifier is a summing unit. The working principle of the circuit in FIG. 1 is that: a Vin ripple is collected by Feedforward Amplifier, and then summed with the output of an error amplifier EA through Summing Amplifier, and the ripple is generated at the output of Summing Amplifier. The output ripple and the Vin input ripple are canceled at a power transistor Mp, thereby canceling the ripple at the output VOUT.

In conjunction with the circuit structure diagram in FIG. 1, it can be seen that the implementation of the FFRC manner requires two operational amplifiers, as well as other electronic components such as resistors and capacitors. The structure is very complex and the stability and transient response of the circuit are affected.

### SUMMARY

An embodiment described herein provides an LDO with ripple rejection, in order to solve the problems that the structure of a circuit for canceling an LDO output ripple with FFRC is complex, and the stability and transient response of the circuit are affected.

According to a first aspect of the present disclosure, an LDO with ripple rejection is provided. The LDO with ripple rejection includes an LDO main circuit, a ripple introduction capacitor, and a first resistor. The LDO main circuit is configured to control an output voltage of the LDO according to a control loop formed by an error amplifier and a power transistor. The ripple introduction capacitor is configured to introduce a ripple at an input end of the LDO into the control loop through the error amplifier. The first resistor is configured to isolate the ripple at the input end of the LDO from an output end of the LDO.

Optionally, one end of the ripple introduction capacitor is coupled to the input end of the LDO, and the other end of the ripple introduction capacitor is respectively coupled to a positive input end of the error amplifier and one end of the first resistor. The other end of the first resistor is coupled to the output end of the LDO.

Optionally, the first resistor is a variable resistor. The variable resistor is configured such that a resistance of the variable resistor is negatively correlated with an impedance from the input end to the output end of the LDO.

Optionally, the LDO main circuit includes the error amplifier, a first power transistor, and an output capacitor. A negative input end of the error amplifier is coupled to a reference voltage, and an output end of the error amplifier is coupled to a control electrode of the first power transistor. A first electrode of the first power transistor is coupled to the input end of the LDO, a second electrode of the first power transistor is respectively coupled to one end of the output capacitor, a load current, and the output end of the LDO, and the other end of the output capacitor is coupled to a ground terminal.

Optionally, the LDO main circuit further includes a second power transistor and a current compensation module. The current compensation module is configured to control a current of the second power transistor to flow into the current compensation module according to a current mirror principle, so as to prevent the current of the second power transistor from flowing into the first resistor. A control electrode of the second power transistor is coupled to the control electrode of the first power transistor, a first electrode of the second power transistor is coupled to the input end of the LDO, and a second electrode of the second power transistor is respectively coupled to the current compensation module and one end of the first resistor.

Optionally, the current compensation module includes a third transistor, a fourth transistor, and a fifth transistor. A control electrode of the third transistor is coupled to the control electrode of the second power transistor, a first electrode of the third transistor is coupled to the input end of the LDO, and a second electrode of the third transistor is respectively coupled to a second electrode of the fourth transistor, a control electrode of the fourth transistor, and a control electrode of the fifth transistor. A first electrode of the fourth transistor and a first electrode of the fifth transistor are both coupled to the ground terminal, and a second electrode of the fifth transistor is coupled to the second electrode of the second power transistor.

Optionally, the resistance of the variable resistor is negatively correlated with the impedance from the input end to the output end of the LDO, including the following situation: the resistance of the variable resistor decreases with the increase of a voltage difference between the input end and the output end of the LDO; or, the resistance of the variable resistor increases with the increase of the load current.

Optionally, a current mirror ratio of the third transistor to the second power transistor is equal to a current mirror ratio of the fourth transistor to the fifth transistor.

Optionally, the first power transistor and the second power transistor are P-type transistors. Optionally, the LDO main loop further includes a second resistor. One end of the second resistor is coupled to an input voltage, and the other end of the second resistor is respectively coupled to the first electrode of the second power transistor and the first electrode of the third transistor.

The LDO with ripple rejection in the embodiment of the present disclosure includes the LDO main circuit, the ripple introduction capacitor, and the first resistor. The LDO main circuit is configured to control the output voltage of the LDO according to the control loop formed by the error amplifier and the power transistor. The ripple introduction capacitor is configured to introduce the ripple at the input end of the LDO into the control loop through the error amplifier. The first resistor is configured to isolate the ripple at the input end of the LDO from the output end of the LDO. Based on the above structure, the LDO with ripple rejection in the embodiment of the present disclosure introduces the ripple at the input end into the input end of the error amplifier through the ripple introduction capacitor, so that the ripple is generated at the output end of the error amplifier, and the ripple is in the same direction as the ripple at the input end of the power transistor. Therefore, the ripple at the output end may be rejected by the common mode cancellation of the power transistor, thereby improving the PSR. Compared with the existing FFRC manner, the ripple rejection structure in the embodiment of the present disclosure may be realized by only adding the capacitors and the resistors. The structure is very simple and has little impact on the stability and transient response of the circuit.

### BRIEF DESCRIPTION OF THE DRAWINGS

In order to more clearly illustrate the technical solutions in the embodiments of the present disclosure more clearly, the drawings of the embodiments will be briefly described below. It is to be known that the drawings described below show merely some embodiments of the present disclosure, rather than limiting the present disclosure.

FIG. 1 shows an existing example circuit diagram of applying FFRC to reject an LDO output ripple.

FIG. 2 shows a schematic circuit diagram of an LDO with ripple rejection according to an embodiment of the present disclosure.

FIG. 3 shows a schematic circuit diagram of another LDO with ripple rejection according to an embodiment of the present disclosure.

FIG. 4 shows a schematic block diagram of still another LDO with ripple rejection according to an embodiment of the present disclosure.

FIG. 5 shows a schematic circuit diagram of still another LDO with ripple rejection according to an embodiment of the present disclosure.

FIG. 6 and FIG. 7 show schematic circuit diagrams of still two LDOs with ripple rejection according to an embodiment of the present disclosure.

Elements in the drawings are schematic and not drawn to scale.

### DETAILED DESCRIPTION OF THE EMBODIMENTS

In order to make the purpose, technical solutions, and advantages of embodiments of the present disclosure clearer, the technical solutions in the embodiments of the present disclosure will be described clearly and completely below with reference to the drawings. It is apparent that the described embodiments are part rather than all embodiments of the present disclosure. On the basis of the description of the embodiments of the present disclosure, all other embodiments obtained by those skilled in the art without creative work shall fall within the scope of protection of the present disclosure.

Unless otherwise defined, all terms used herein (including technical and scientific terms) have the same meanings as those commonly understood by those skilled in the art that the subject of the present disclosure belongs. Further, it is to be understood that terms such as those defined in commonly used dictionaries should be interpreted as having the meanings consistent with those in the context of the specification and related technologies, and will not be interpreted in an idealized or overly formal form, unless otherwise defined herein. As used herein, the statement that two or more parts are “connected” or “coupled” together shall mean that these parts are combined directly or through one or more intermediate parts.

In all embodiments of the present disclosure, since a source and a drain of a Metal Oxide Semiconductor (MOS) transistor are symmetrical, and on current directions between the sources and the drains of an N-type transistor and a P-type transistor are opposite, in the embodiments of the present disclosure, a controlled middle end of the MOS transistor is referred to as a control electrode, and the remaining two ends of the MOS transistor are referred to as a first electrode and a second electrode, respectively. In addition, terms such as “first” and “second” are only used for distinguishing one component (or one part of a component) from another component (or another part of a component).

In order to solve the problems that the structure of a circuit for canceling an LDO output ripple with FFRC is complex, and the stability and transient response of a circuit are affected, a new ripple cancellation technology is proposed. The LDO with ripple rejection in the embodiment of the present disclosure introduces a ripple of a power supply (input end) into an input end of an error amplifier through a capacitor, a ripple is generated at an output end of the error amplifier, and the ripple and an input end of a power transistor are canceled, thereby rejecting the ripple at the output end, and improving the PSR. The LDO with ripple rejection of the present disclosure is described in detail below.

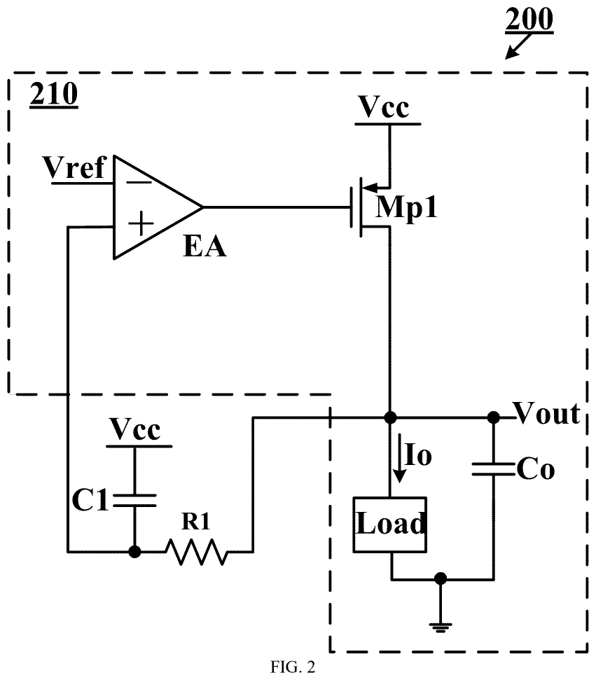

FIG. 2 shows a schematic block diagram of an LDO 200 with ripple rejection according to an embodiment of the present disclosure. As shown in FIG. 2, the LDO 200 with ripple rejection includes an LDO main circuit 210, a ripple introduction capacitor C1, and a first resistor R1.

The LDO main circuit 210 is configured to control an output voltage of the LDO 200 according to a control loop formed by an error amplifier and a power transistor. The LDO main circuit 210 is a basic structural circuit of the LDO. The main working process of the LDO main circuit 210 is to compare the output voltage with a reference voltage, and output a gate voltage of the power transistor through the output end of the error amplifier. When a load change causes the output voltage to drop, after the output voltage is compared with the reference voltage, the output of the error amplifier may decrease, so that the gate voltage of the power transistor decreases, thereby increasing a voltage difference between a gate and a source of the power transistor, and an output current may increase. The increase in output current may cause the output voltage to rise, and the output voltage returns to a normal voltage value.

The ripple introduction capacitor C1 is configured to introduce a ripple at an input end Vcc of the LDO 200 into the control loop (the control loop of the LDO main circuit) through the error amplifier. Specifically, one end of the ripple introduction capacitor C1 is coupled to the input end Vcc of the LDO 200, and the other end thereof is coupled to a positive input end of the error amplifier. The first resistor R1 is respectively coupled to the ripple introduction capacitor C1 and an output end Vout of the LDO 200, and is configured to isolate the ripple at the input end Vcc of the LDO 200 from the output end Vout of the LDO 200.

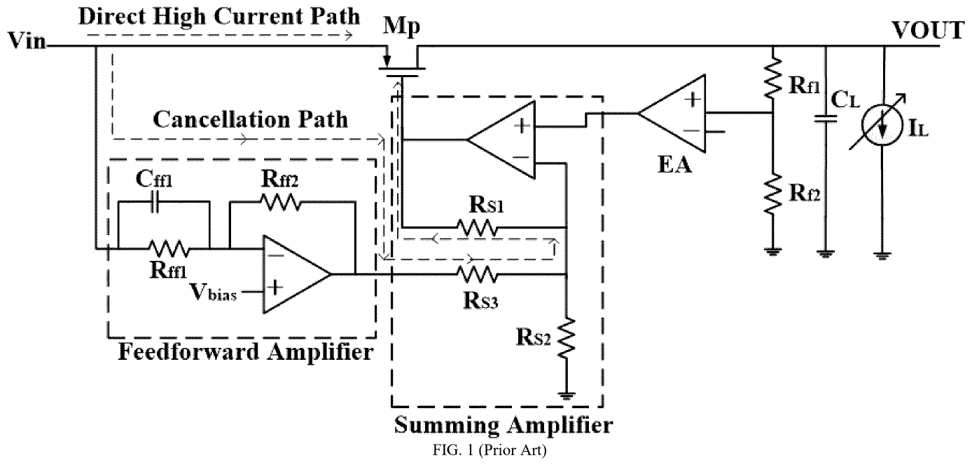

Further, as shown in FIG. 2, the LDO main circuit 210 further includes an output capacitor Co in addition to the error amplifier EA and the power transistor (the first power transistor MP1 in FIG. 2). A negative input end of the error amplifier EA is coupled to the reference voltage Vref, and the output end of the error amplifier EA is coupled to a control electrode of the first power transistor MP1. A first electrode of the first power transistor MP1 is coupled to the input end Vcc of the LDO 200, and a second electrode of the first power transistor MP1 is respectively coupled to one end of the output capacitor Co, a load current Io, and the output end Vout of the LDO 200, and the other end of the output capacitor Co is coupled to a ground terminal. One end of the ripple introduction capacitor C1 is coupled to the input end Vcc of the LDO 200, and the other end of the ripple introduction capacitor C1 is respectively coupled to the positive input end of the error amplifier EA and one end of the first resistor R1. The other end of the first resistor R1 is coupled to the output end Vout of the LDO 200. The LDO main circuit 210 in FIG. 2 is an exemplary circuit diagram, and of course, a series voltage divider resistor may also be added to the output end Vout as in FIG. 1. It may also be of an LDO circuit structure including other functions (except a ripple rejection function). The circuit structure of the LDO main circuit 210 is not limited in the embodiment. The main emphasis is on the structures of the ripple introduction capacitor C1 and the first resistor R1.

In conjunction with FIG. 2, the ripple rejection principle of the LDO 200 with ripple rejection in the embodiment of the present disclosure is explained: the ripple introduction capacitor C1 is coupled between the input end Vcc and the positive input end of the error amplifier EA, so that the ripple at the input end Vcc may be introduced into the control loop in the LDO main circuit 210 through the positive input end, and the ripple in the same direction as the input end Vcc of the LDO 200 is generated at the output end of the error amplifier EA. The ripple is in the same direction as the ripple at the input end Vcc on the first power transistor MP1, so that the ripple at the output end Vout may be rejected by the common mode cancellation of the first power transistor MP1, thereby improving the PSR. In addition, the first resistor R1 is to isolate the output end Vout from the ripple introduction capacitor C1. If there is no first resistor R1, the ripple introduction capacitor C1 may be directly coupled to the output end Vout. The LDO 200 has a low resistance characteristic, so that the output end Vout may directly absorb the ripple at the input end Vcc, and the ripple rejection effect cannot be achieved.

From the above description, it can be seen that, in the LDO 200 with ripple rejection in the embodiment of the present disclosure, the ripple at the input end Vcc is introduced into the positive input end of the error amplifier EA through the ripple introduction capacitor C1, so that the ripple is generated at the output end of the error amplifier EA, and the ripple is in the same direction as the ripple at the input end Vcc on the first power transistor MP1. Therefore, the ripple at the output end Vout may be rejected by the common mode cancellation of the first power transistor MP1, thereby improving the PSR. Compared with the existing FFRC manner, the ripple rejection structure in the embodiment of the present disclosure may be realized by only adding the capacitors and the resistors. The structure is very simple and has little impact on the stability and transient response of the circuit.

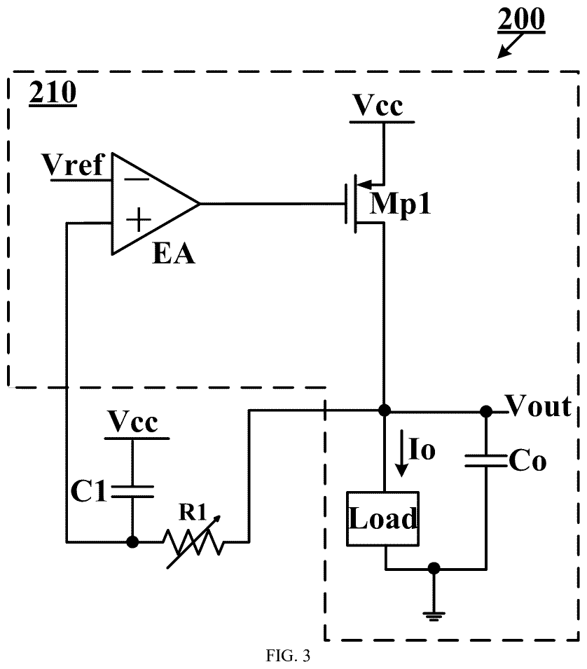

Further, as shown in FIG. 3, the embodiment of the present disclosure further provides an exemplary circuit diagram of another LDO 200 with ripple rejection. The difference from FIG. 2 is that the first resistor R1 in FIG. 2 is arranged as a variable resistor in FIG. 3 to achieve dynamic ripple rejection. Specifically, a resistance of the variable resistor is negatively correlated with an impedance from the input end Vcc to the output end Vout of the LDO 200. In practical applications, the resistance of the variable resistor may be adjusted according to the following rules: the resistance of the variable resistor decreases with the increase of a voltage difference between the input end Vcc and the output end Vout; and under the premise that the voltage difference between the input end Vcc and the output end Vout remains unchanged, the resistance of the variable resistor increases with the increase of the load current Io. The principle of dynamic ripple rejection is analyzed in conjunction with FIG. 3: when the voltage difference between the input end Vcc and the output end Vout becomes larger, the amplitude of the ripple that needs to be coupled to the positive input end of the error amplifier EA becomes smaller (that is, the intensity coupled to the positive input end of the error amplifier EA is attenuated more), so that the resistance of the variable resistor may be adjusted to be smaller, and part of the amplitude is absorbed by the output end Vout; and when the voltage difference between the input end Vcc and the output end Vout becomes smaller, the amplitude of the ripple that needs to be coupled to the positive input end of the error amplifier EA becomes larger (that is, the intensity coupled to the positive input end of the error amplifier EA is attenuated less), so that the resistance of the variable resistor may be adjusted to be larger to increase the amplitude absorbed by the output end Vout. In a case where the voltage difference between the input end Vcc and the output end Vout remains unchanged, when the load current Io becomes larger, the impedance from the input end Vcc to the output end Vout becomes smaller, and the amplitude of the ripple that needs to be coupled to the positive input end of the error amplifier EA becomes larger, so that the resistance of the variable resistor may be adjusted to be larger; and conversely, when the load current Io becomes smaller, the impedance from the input end Vcc to the output end Vout becomes larger, and the amplitude of the ripple that needs to be coupled to the positive input end of the error amplifier EA becomes smaller, so that the resistance of the variable resistor may be adjusted to be smaller.

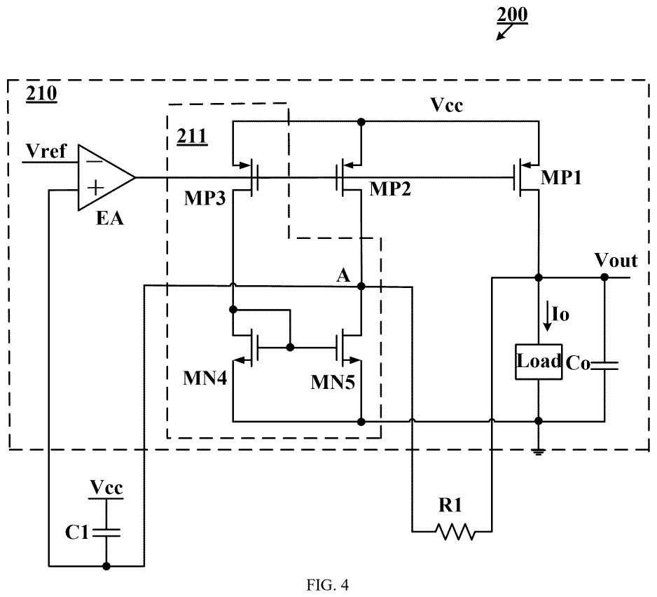

Further, as shown in FIG. 4, the embodiment of the present disclosure further provides an exemplary circuit diagram of another LDO 200 with ripple rejection. FIG. 4 differs from FIG. 2 in that the structure of the LDO main circuit 210 is different, and others are the same. In FIG. 4, the LDO main circuit 210 includes, in addition to the error amplifier EA, the first power transistor MP1, and the output capacitor Co shown in FIG. 2, a second power transistor MP2 and a current compensation module 211. The current compensation module 211 is configured to control a current of the second power transistor MP2 to flow into the current compensation module 211 according to a current mirror principle, so as to prevent the current of the second power transistor MP2 from flowing into the first resistor R1. A control electrode of the second power transistor MP2 is coupled to the control electrode of the first power transistor MP1, a first electrode of the second power transistor MP2 is coupled to the input end Vcc of the LDO 200, and a second electrode of the second power transistor MP2 is respectively coupled to the current compensation module 211 and one end of the first resistor R1. The first power transistor MP1 and the second power transistor MP2 are P-type transistors, such as P-type MOS transistors.

Further, as shown in FIG. 4, the current compensation module 211 includes a third transistor MP3, a fourth transistor MN4, and a fifth transistor MN5. A control electrode of the third transistor MP3 is coupled to the control electrode of the second power transistor MP2, a first electrode of the third transistor MP3 is coupled to the input end Vcc of the LDO 200, and a second electrode of the third transistor MP3 is respectively coupled to a second electrode of the fourth transistor MN4, a control electrode of the fourth transistor MN4, and a control electrode of the fifth transistor MN5. A first electrode of the fourth transistor MN4 and a first electrode of the fifth transistor MN5 are both coupled to the ground terminal, and a second electrode of the fifth transistor MN5 is coupled to the second electrode of the second power transistor MP2. The third transistor MP3 is a P-type transistor, specifically a P-type MOS transistor, and the fourth transistor MN4 and the fifth transistor MN5 are N-type transistors, specifically N-type MOS transistors. A current mirror ratio of the third transistor MP3 to the second power transistor MP2 is equal to a current mirror ratio of the fourth transistor MN4 to the fifth transistor MN5.

The ripple rejection principle in FIG. 4 is the same as that in FIG. 2: the ripple at the input end Vcc is introduced into the positive input end of EA through C1, so that the ripple in the same direction as the input end Vcc is generated at the output end of EA, and the ripple is in the same direction as the ripple at the input end Vcc on the first power transistor MP1. Therefore, the ripple at the output end Vout may be rejected by the common mode cancellation of the first power transistor MP1, thereby improving the PSR. In the exemplary circuit diagram of FIG. 4, the first power transistor MP1 and the output capacitor Co are isolated outside an LDO small loop (the second power transistor MP2 in FIG. 4 is a mirror transistor of the first power transistor MP1, MP2 is a power transistor of very small size, and EA and the second power transistor MP2 form the LDO small loop) by adding the second power transistor MP2 and the current compensation module 211, so that the impact of the capacitance of the output capacitor Co on the stability of the circuit may be reduced, especially when the input capacitor is a large capacitor, the effect is more obvious. Specifically, in FIG. 4, when the load current Io becomes larger, the current flowing through the first power transistor MP1 becomes larger. The second power transistor MP2 is the mirror transistor of the first power transistor MP1, which may facilitate increasing in a gate-source voltage Vgs of the second power transistor MP2. At the same time, the current of the third transistor MP3, which is the mirror transistor of the second power transistor MP2, may also become larger, and the third transistor MP3 and the fourth transistor MN4 are on the same current path, so that the current flowing through the fourth transistor MN4 is equal to the current flowing through the third transistor MP3. Further, since the current mirror ratio of the third transistor MP3 to the second power transistor MP2 is equal to the current mirror ratio of the fourth transistor MN4 to the fifth transistor MN5, the current flowing through the fifth transistor MN5 is equal to the current flowing through the second power transistor MP2, that is, MN5 may provide as much current as MP2 needs, thereby reducing the current flowing to the load through the first resistor R1. Ideally (MP2 and MP3, as well as MN4 and MN5 are well matched), the current flowing through R1 is zero, which may ensure that the voltage at a point A is also equal to Vout. It can be seen that the first resistor R1 in FIG. 4 may also play a role in isolating the output capacitor Co and the first power transistor MP1 from the outside of the LDO loop, thereby reducing the impact of the output capacitor Co on the stability of the circuit.

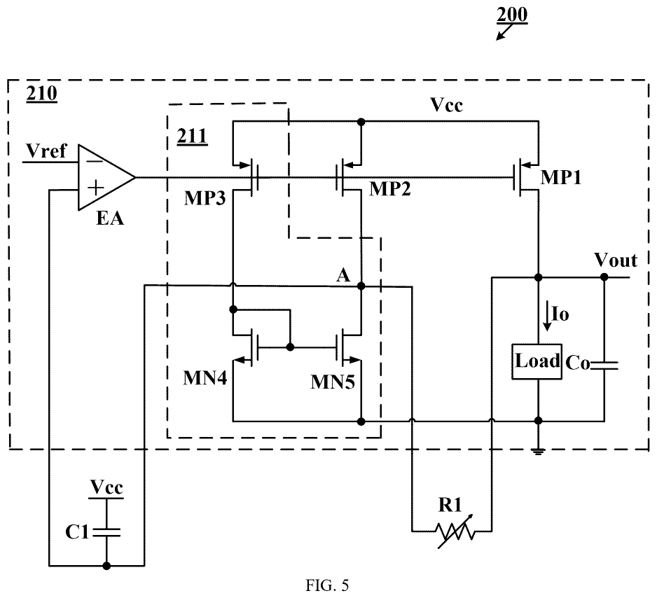

Further, as shown in FIG. 5, the embodiment of the present disclosure further provides an exemplary circuit diagram of another LDO 200 with ripple rejection. The difference from FIG. 4 is that the first resistor R1 in FIG. 4 is arranged as a variable resistor in FIG. 5 to achieve dynamic ripple rejection. The principle of dynamic ripple rejection is the same as that in the embodiment of FIG. 3, and will not be elaborated here.

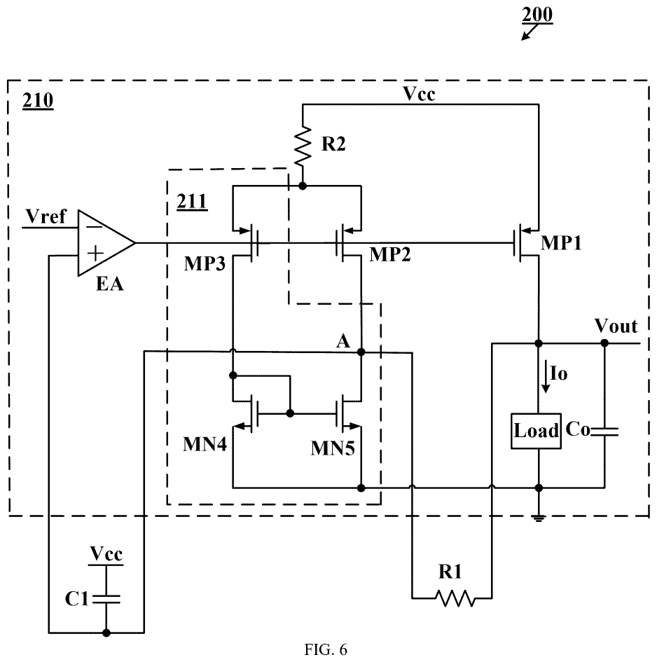

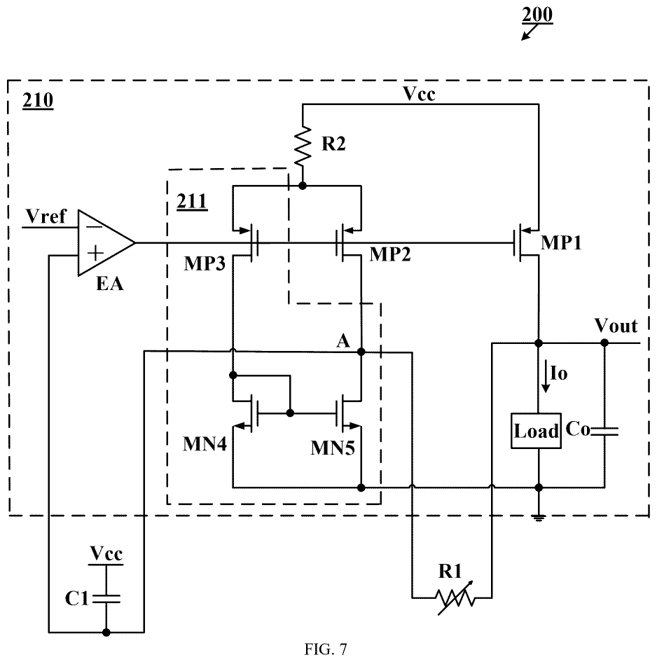

Further, as shown in FIG. 6 and FIG. 7, the embodiment of the present disclosure further provides circuit diagrams of another two LDOs 200 with ripple rejection. Compared with FIG. 4 and FIG. 5, FIG. 6 adds a second resistor R2 based on FIG. 4, and FIG. 7 adds the second resistor R2 based on FIG. 5. One end of the second resistor R2 is coupled to the input voltage Vcc, and the other end of the second resistor R2 is coupled to the second power transistor Mp2 and the first electrode of the third transistor Mp3. The second resistor R2 is added to reduce power consumption, especially when the load current Io is large, the second resistor R2 may cause a ratio of the current flowing through the second power transistor Mp2 to the current flowing through the first power transistor Mp1 to be not consistent with a size ratio of the second power transistor Mp2 to the first power transistor Mp1 (consistent in FIG. 4 and FIG. 5). That is, when the current of the first power transistor Mp1 is large, the current flowing through the second power transistor Mp2 may be made smaller than that in FIG. 4 and FIG. 5 through the second resistor R2, thereby reducing the power consumption of (Mp2, Mp3, Mn4, and Mn5).

The embodiment of the present disclosure further provides an electronic device, including the LDO 200 with ripple rejection in the above embodiment. The electronic device may be a mobile terminal (mobile phone, tablet computer, wearable smart device, etc.), a camera (car camera, etc.), or other electronic devices with high power requirements.

In summary, the LDO with ripple rejection in the embodiment of the present disclosure can introduce the ripple of the power supply into the input end of the error amplifier through the capacitor, and at the same time, the resistor or the variable resistor is added between the capacitor and the output end for isolation, so as to achieve rejection of the output ripple. The structure is very simple, and the impact on the stability and transient response of the circuit is very small.

Unless otherwise indicated clearly in the context, the singular form of terms used herein and in the appended claims includes the plural, and vice versa. Therefore, when referring to the singular, it usually includes the plural of the corresponding term. Similarly, the words “include” and “comprise” will be interpreted as inclusive rather than exclusive. Similarly, the terms “include” and “or” shall be interpreted as including, unless such interpretation is expressly prohibited herein. Where the term “example” is used herein, particularly when it is behind a group of terms, the “example” is only exemplary and illustrative, and should not be considered exclusive or extensive.

Further aspects and scope of adaptability become apparent from the description provided herein. It is to be understood that various aspects of the present disclosure may be implemented separately or in combination with one or more other aspects. It is also to be understood that the description and specific embodiments herein are for illustrative purposes only and are not intended to limit the scope of the present disclosure.

Several embodiments of the present disclosure have been described in detail above. However, apparently, those skilled in the art can make various modifications and variants to the embodiments of the present disclosure without departing from the spirit and scope of the present disclosure. The scope of the present disclosure is limited by the appended claims.

What is claimed is:

1. A Low Dropout Regulator (LDO) with a ripple rejection, comprising an LDO main circuit, a ripple introduction capacitor, and a first resistor;
wherein the LDO main circuit is configured to control an output voltage of the LDO according to a control loop formed by an error amplifier and a power transistor;
the ripple introduction capacitor is configured to introduce a ripple at an input end of the LDO into the control loop through the error amplifier;
the first resistor is configured to isolate the ripple at the input end of the LDO from an output end of the LDO; and
a first end of the ripple introduction capacitor is coupled to the input end of the LDO, and a second end of the ripple introduction capacitor is respectively coupled to a positive input end of the error amplifier and a first end of the first resistor; and a second end of the first resistor is coupled to the output end of the LDO.

2. (canceled)

3. The LDO with the ripple rejection according to claim 1, wherein the first resistor is a variable resistor;
wherein resistance of the variable resistor is negatively correlated with an impedance from the input end of the LDO to the output end of the LDO.

4. The LDO with the ripple rejection according to claim 3, wherein the LDO main circuit comprises the error amplifier, a first power transistor, and an output capacitor;
wherein a negative input end of the error amplifier is coupled to a reference voltage, and an output end of the error amplifier is coupled to a control electrode of the first power transistor; and
a first electrode of the first power transistor is coupled to the input end of the LDO, a second electrode of the first power transistor is respectively coupled to a first end of the output capacitor, a load current and the output end of the LDO, and a second end of the output capacitor is coupled to a ground terminal.

5. The LDO with the ripple rejection according to claim 4, wherein the LDO main circuit further comprises a second power transistor and a current compensation module;
wherein the current compensation module is configured to control a current of the second power transistor to flow into the current compensation module according to a current mirror principle, to prevent the current of the second power transistor from flowing into the first resistor; and
a control electrode of the second power transistor is coupled to the control electrode of the first power transistor, a first electrode of the second power transistor is coupled to the input end of the LDO, and a second electrode of the second power transistor is respectively coupled to the current compensation module and the first end of the first resistor.

6. The LDO with the ripple rejection according to claim 5, wherein the current compensation module comprises a third transistor, a fourth transistor, and a fifth transistor;
wherein a control electrode of the third transistor is coupled to the control electrode of the second power transistor, a first electrode of the third transistor is coupled to the input end of the LDO, and a second electrode of the third transistor is respectively coupled to a second electrode of the fourth transistor, a control electrode of the fourth transistor and a control electrode of the fifth transistor; and
a first electrode of the fourth transistor and a first electrode of the fifth transistor are both coupled to the ground terminal, and a second electrode of the fifth transistor is coupled to the second electrode of the second power transistor.

7. The LDO with the ripple rejection according to claim 4, wherein the resistance of the variable resistor is negatively correlated with the impedance from the input end of the LDO to the output end of the LDO, comprising the following situation:
the resistance of the variable resistor decreases with an increase of a voltage difference between the input end of the LDO and the output end of the LDO; or,
the resistance of the variable resistor increases with an increase of the load current.

8. The LDO with the ripple rejection according to claim 6, wherein a current mirror ratio of the third transistor to the second power transistor is equal to a current mirror ratio of the fourth transistor to the fifth transistor.

9. The LDO with the ripple rejection according to claim 5, wherein the first power transistor and the second power transistor are P-type transistors.

10. The LDO with the ripple rejection according to claim 6, wherein the LDO main circuit further comprises a second resistor;
wherein a first end of the second resistor is coupled to an input voltage, and a second end of the second resistor is respectively coupled to the first electrode of the second power transistor and the first electrode of the third transistor.
